(19) United States
(12) Patent Application Publication
(10) Pub. No.: US 2026/0339755 A1
(43) Pub. Date: Oct. 29, 2026

(54) DETECTING AND RESOLVING DEADLOCKS IN DATA CONCURRENT PROCESSING SYSTEMS

(71) Applicant: International Business Machines Corporation, Armonk, NY (US)

(72) Inventors: Bao Zhang, Beijing (CN); Peng Hui Jiang, Beijing (CN); Xin Zhe Wang, Beijing (CN); Chu Yan Peng, Beijing (CN); Qing Hua Feng, Beijing (CN); Jing Wang, Beijing (CN)

(21) Appl. No.: 19/188,455

(22) Filed: Apr. 24, 2025

(51) Int. Cl. G06F 9/52

(52) U.S. Cl. CPC G06F 9/524; G06F 9/526

(57) ABSTRACT

A computer-implemented method, system, and computer program product for detecting and resolving deadlocks. A model is trained to detect potential deadlocks in data concurrent processing systems using collected static historical data (e.g., common data provider (CDP) analysis reports, omegamon data provider (ODP) analysis reports, performance analysis reports, historical profiling data, etc.) on data concurrent processing systems. After training such a model to detect potential deadlocks, a data concurrent processing system is monitored to collect system status data. Based on the collected system status data, the trained model determines if a potential deadlock has been detected. If a potential deadlock has been detected, then an action to resolve the potential deadlock is performed. The potential deadlock is attempted to be resolved (i.e., preventing the deadlock from actually occurring) based on processor usage or running time. In this manner, deadlocks in data concurrent processing systems can be effectively detected and resolved.

### TECHNICAL FIELD

The present disclosure relates generally to data concurrent processing systems, and more particularly to detecting and resolving deadlocks in data concurrent processing systems using a trained model to detect potential deadlocks, which are attempted to be resolved within runtime.

### BACKGROUND

A data concurrent processing system is a system that allows multiple users or processes to access and modify shared data simultaneously without causing conflicts or inconsistencies. That is, a data concurrent processing system enables multiple operations on the same data to occur concurrently while maintaining data integrity. For example, multiple operations on the same data may occur concurrently while maintaining data integrity by using mechanisms, such as locking and isolation levels.

In a data concurrent processing system, a “deadlock” occurs when two or more processes are stuck waiting for each other to release resources they need to proceed thereby creating a circular dependency where none of the processes can move forward. For example, a deadlock occurs when each process holds a lock on a resource that another process needs to access resulting in a standstill where no progress can be made. As a result, each process ends up waiting for the other to release the lock. Consequently, the system becomes halted due to this mutual waiting situation.

Attempts have been made to prevent and/or resolve deadlocks. For example, a specific order for acquiring resources may be enforced thereby ensuring that the processes always acquire locks in the same sequence. Unfortunately, such a technique significantly reduces system efficiency by imposing strict rules on resource acquisition.

Another example in attempting to prevent and/or resolve deadlocks is to set timeouts on lock acquisition attempts thereby allowing a process to release a lock and retry if it is unable to acquire the required resource within a specified time. Unfortunately, such a technique may result in process starvation, where a process might be prematurely terminated or significantly delayed if it cannot acquire a necessary resource within the allotted time frame even if the resource eventually becomes available potentially leading to system inefficiency and data loss in critical situations.

A further example in attempting to prevent and/or resolve deadlocks is to implement proper transaction management techniques to handle locking and ensure that transactions are properly committed or rolled back to avoid deadlocks. Unfortunately, such a technique may result in a decrease in system performance as acquiring and releasing locks can add overhead to operations, especially in high-concurrency scenarios where many processes are competing for access to data potentially leading to wait times and impacting responsiveness.

As a result, there is not currently an effective means for detecting and resolving deadlocks in data concurrent processing systems.

### SUMMARY

In one embodiment of the present disclosure, a computer-implemented method for detecting and resolving deadlocks comprises training a model to detect potential deadlocks in data concurrent processing systems using collected static historical data. The method further comprises monitoring a data concurrent processing system to collect system status data. The method additionally comprises detecting a potential deadlock in the data concurrent processing system by the trained model using the collected system status data. Furthermore, the method comprises performing an action to resolve the potential deadlock.

Furthermore, in one embodiment of the present disclosure, the method additionally comprises identifying a priority of a first task and a second task involved in the potential deadlock. The method further comprises suspending the first task until the second task completes its unit of work in response to the priority being assigned to the first task being lower than the priority assigned to the second task by a first threshold amount. Furthermore, the method comprises suspending the first task until the second task completes its unit of work in response to a remaining processor usage time of the first task exceeding the remaining processor usage time of the second task by a second threshold amount. Additionally, the method comprises suspending the first task until the second task completes its unit of work in response to an accumulated processor usage time of the first task being less than the accumulated processor usage time of the second task by a third threshold amount.

Additionally, in one embodiment of the present disclosure, the method further comprises identifying a priority of a first task and a second task involved in the potential deadlock. The method additionally comprises suspending the first task until the second task completes its unit of work in response to the priority being assigned to the first task being lower than the priority assigned to the second task by a first threshold amount. Furthermore, the method comprises suspending the first task until the second task completes its unit of work in response to a current running time of the first task being less than the current running time of the second task by a second threshold amount. Additionally, the method comprises suspending the first task until the second task completes its unit of work in response to a remaining completion time of the first task exceeding the remaining completion time of the second task by a third threshold amount.

Furthermore, in one embodiment of the present disclosure, the method additionally comprises monitoring the data concurrent processing system to collect additional system status data upon performing the action to resolve the potential deadlock. The method further comprises determining if a system status of the data concurrent processing system returns to normal based on the additional system status data. Furthermore, the method comprises analyzing a first process and a second process of the data concurrent processing system involved in the potential deadlock to determine if a deadlock exists in response to the system status of the data concurrent processing system not returning to normal.

Additionally, in one embodiment of the present disclosure, the method further comprises identifying a thread from one of the first process and the second process which can be revoked with a mutex safely. The method additionally comprises hanging the identified thread.

Furthermore, in one embodiment of the present disclosure, the method additionally comprises releasing the mutex from the identified thread so that another thread acquires the mutex to access a shared resource. The method further comprises adding the identified thread to a queue for availability of the mutex.

Additionally, in one embodiment of the present disclosure, the method further comprises calculating a reward of a current action to refine the trained model.

Other forms of the embodiment of the computer-implemented method described above are in a system and in a computer program product.

Accordingly, embodiments of the present disclosure effectively detect and resolve deadlocks in data concurrent processing systems.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates an embodiment of the present disclosure of a computing environment for practicing the principles of the present disclosure;

FIG. 2 illustrates a system architecture for detecting and resolving deadlocks in data concurrent processing systems in accordance with an embodiment of the present disclosure;

FIG. 3 is a flowchart of a method for training a model to detect potential deadlocks in data concurrent processing systems in accordance with an embodiment of the present disclosure;

FIG. 4 illustrates features of static historical data being utilized for detecting potential deadlocks in accordance with an embodiment of the present disclosure;

FIG. 5 illustrates training a model to detect potential deadlocks using a decision tree in accordance with an embodiment of the present disclosure;

FIGS. 6A-6B are a flowchart of a method for detecting and resolving deadlocks in accordance with an embodiment of the present disclosure;

FIG. 7 illustrates an exemplary central processor unit (CPU) usage status of various tasks being performed in accordance with an embodiment of the present disclosure;

FIG. 8 illustrates an exemplary running status of various tasks being performed in accordance with an embodiment of the present disclosure;

FIG. 9 is a flowchart of a method for resolving potential deadlocks based on processor usage in accordance with an embodiment of the present disclosure; and

FIG. 10 is a flowchart of a method for resolving potential deadlocks based on running time in accordance with an embodiment of the present disclosure.

### DETAILED DESCRIPTION

In one embodiment of the present disclosure, a computer-implemented method for detecting and resolving deadlocks comprises training a model to detect potential deadlocks in data concurrent processing systems using collected static historical data. The method further comprises monitoring a data concurrent processing system to collect system status data. The method additionally comprises detecting a potential deadlock in the data concurrent processing system by the trained model using the collected system status data. Furthermore, the method comprises performing an action to resolve the potential deadlock.

In this manner, deadlocks are effectively detected and resolved in data concurrent processing systems.

Furthermore, in one embodiment of the present disclosure, the method additionally comprises identifying a priority of a first task and a second task involved in the potential deadlock. The method further comprises suspending the first task until the second task completes its unit of work in response to the priority being assigned to the first task being lower than the priority assigned to the second task by a first threshold amount. Furthermore, the method comprises suspending the first task until the second task completes its unit of work in response to a remaining processor usage time of the first task exceeding the remaining processor usage time of the second task by a second threshold amount. Additionally, the method comprises suspending the first task until the second task completes its unit of work in response to an accumulated processor usage time of the first task being less than the accumulated processor usage time of the second task by a third threshold amount.

In this manner, deadlocks are prevented from occurring in data concurrent processing systems based on processor (CPU) usage.

Additionally, in one embodiment of the present disclosure, the method further comprises identifying a priority of a first task and a second task involved in the potential deadlock. The method additionally comprises suspending the first task until the second task completes its unit of work in response to the priority being assigned to the first task being lower than the priority assigned to the second task by a first threshold amount. Furthermore, the method comprises suspending the first task until the second task completes its unit of work in response to a current running time of the first task being less than the current running time of the second task by a second threshold amount. Additionally, the method comprises suspending the first task until the second task completes its unit of work in response to a remaining completion time of the first task exceeding the remaining completion time of the second task by a third threshold amount.

In this manner, deadlocks are prevented from occurring in data concurrent processing systems based on running time.

Furthermore, in one embodiment of the present disclosure, the method additionally comprises monitoring the data concurrent processing system to collect additional system status data upon performing the action to resolve the potential deadlock. The method further comprises determining if a system status of the data concurrent processing system returns to normal based on the additional system status data. Furthermore, the method comprises analyzing a first process and a second process of the data concurrent processing system involved in the potential deadlock to determine if a deadlock exists in response to the system status of the data concurrent processing system not returning to normal.

In this manner, it is determined if the detected potential deadlock corresponds to a deadlock that has actually occurred in the data concurrent processing system.

Additionally, in one embodiment of the present disclosure, the method further comprises identifying a thread from one of the first process and the second process which can be revoked with a mutex safely. The method additionally comprises hanging the identified thread.

In this manner, runtime dynamically manages deadlocks without requiring the changing of the program source code or recompiling the program.

Furthermore, in one embodiment of the present disclosure, the method additionally comprises releasing the mutex from the identified thread so that another thread acquires the mutex to access a shared resource. The method further comprises adding the identified thread to a queue for availability of the mutex.

In this manner, runtime dynamically manages deadlocks without requiring the changing of the program source code or recompiling the program.

Additionally, in one embodiment of the present disclosure, the method further comprises calculating a reward of a current action to refine the trained model.

In this manner, the trained model will be better able to detect potential deadlocks.

Other forms of the embodiment of the computer-implemented method described above are in a system and in a computer program product.

As stated above, in a data concurrent processing system, a “deadlock” occurs when two or more processes are stuck waiting for each other to release resources they need to proceed thereby creating a circular dependency where none of the processes can move forward. For example, a deadlock occurs when each process holds a lock on a resource that another process needs to access resulting in a standstill where no progress can be made. As a result, each process ends up waiting for the other to release the lock. Consequently, the system becomes halted due to this mutual waiting situation.

Attempts have been made to prevent and/or resolve deadlocks. For example, a specific order for acquiring resources may be enforced thereby ensuring that the processes always acquire locks in the same sequence. Unfortunately, such a technique significantly reduces system efficiency by imposing strict rules on resource acquisition.

Another example in attempting to prevent and/or resolve deadlocks is to set timeouts on lock acquisition attempts thereby allowing a process to release a lock and retry if it is unable to acquire the required resource within a specified time. Unfortunately, such a technique may result in process starvation, where a process might be prematurely terminated or significantly delayed if it cannot acquire a necessary resource within the allotted time frame even if the resource eventually becomes available potentially leading to system inefficiency and data loss in critical situations.

A further example in attempting to prevent and/or resolve deadlocks is to implement proper transaction management techniques to handle locking and ensure that transactions are properly committed or rolled back to avoid deadlocks. Unfortunately, such a technique may result in a decrease in system performance as acquiring and releasing locks can add overhead to operations, especially in high-concurrency scenarios where many processes are competing for access to data potentially leading to wait times and impacting responsiveness.

As a result, there is not currently an effective means for detecting and resolving deadlocks in data concurrent processing systems.

The embodiments of the present disclosure provide a means for effectively detecting and resolving deadlocks in data concurrent processing systems. In one embodiment, a model is trained to detect potential deadlocks in data concurrent processing systems using collected static historical data (e.g., common data provider (CDP) analysis reports, omegamon data provider (ODP) analysis reports, performance analysis reports, historical profiling data, etc.) on data concurrent processing systems. After training such a model to detect potential deadlocks, a data concurrent processing system is monitored to collect system status data. System status data, as used herein, refers to information about the state of the system's hardware and software. Based on the collected system status data, the trained model determines if a potential deadlock has been detected. If a potential deadlock has been detected, then an action to resolve the potential deadlock is performed. In one embodiment, the potential deadlock is attempted to be resolved (i.e., preventing the deadlock from actually occurring) based on processor usage or running time. Upon performing such an action to resolve the potential deadlock, it is determined if the system status returned to normal. If the system status does not return to normal, then it is determined if a deadlock has actually occurred in the data processing system. In one embodiment, such a determination is performed by using the wait-for-graph approach involving a graphical representation of the systems' processes and resources, where a cycle in the graph indicates a deadlock. In another embodiment, such a determination is performed by using a resource allocation graph, where a cycle in the graph indicates a deadlock. In a further embodiment, such a determination is performed by detecting the occurrence of deadlock conditions based on logged information. If a deadlock has occurred in the data processing system, then an action is performed to resolve the deadlock. In one embodiment, such an action involves identifying the thread which can be revoked with the mutex (mutual exclusion (mutex) is a program object that prevents multiple threads (smaller unit of execution that exists within a process) from accessing the same shared resource simultaneously) safely. The identified thread is then hung. That is, the identified thread is prevented from completing its task/job. The mutex from the identified thread is then released so that another thread can acquire the mutex to access the shared resource. The identified thread is then added to a queue to wait for the availability of the mutex. Once it becomes available, the identified thread acquires the mutex so that it can access the shared resource. Furthermore, in one embodiment, a reward of the current action (i.e., the action that was performed) is calculated and used to refine the trained model. In this manner, deadlocks in data concurrent processing systems can be effectively detected and resolved. A further description of these and other features will be provided below.

In some embodiments of the present disclosure, the present disclosure comprises a computer-implemented method, system, and computer program product for detecting and resolving deadlocks. In one embodiment of the present disclosure, a model is trained to detect potential deadlocks in data concurrent processing systems using collected static historical data (e.g., common data provider (CDP) analysis reports, omegamon data provider (ODP) analysis reports, performance analysis reports, historical profiling data, etc.) on data concurrent processing systems. After training such a model to detect potential deadlocks, a data concurrent processing system is monitored to collect system status data. System status data, as used herein, refers to information about the state of the system's hardware and software. Based on the collected system status data, the trained model determines if a potential deadlock has been detected. If a potential deadlock has been detected, then an action to resolve the potential deadlock is performed. In one embodiment, the potential deadlock is attempted to be resolved (i.e., preventing the deadlock from actually occurring) based on processor usage or running time. In this manner, deadlocks in data concurrent processing systems can be effectively detected and resolved.

In the following description, numerous specific details are set forth to provide a thorough understanding of the present disclosure. However, it will be apparent to those skilled in the art that the present disclosure may be practiced without such specific details. In other instances, well-known circuits have been shown in block diagram form in order not to obscure the present disclosure in unnecessary detail. For the most part, details considering timing considerations and the like have been omitted inasmuch as such details are not necessary to obtain a complete understanding of the present disclosure and are within the skills of persons of ordinary skill in the relevant art.

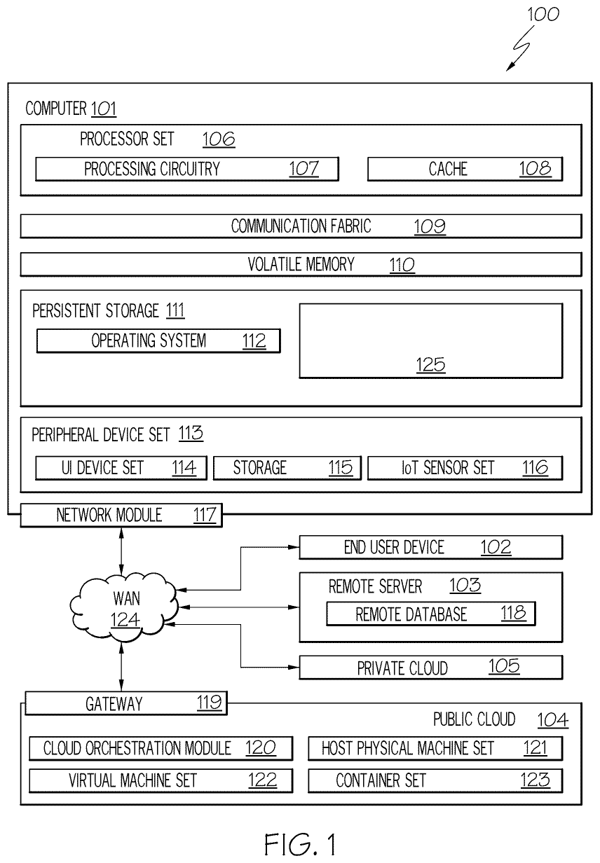

Referring now to the Figures in detail, FIG. 1 illustrates an embodiment of the present disclosure of a computing environment 100 for practicing the principles of the present disclosure.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code (stored in block 125) involved in performing the inventive methods, such as effectively detecting and resolving deadlocks in data concurrent processing systems. In addition to block 125, computing environment 100 includes, for example, computer 101, network 124, such as a wide area network (WAN), end user device (EUD) 102, remote server 103, public cloud 104, and private cloud 105. In this embodiment, computer 101 includes processor set 106 (including processing circuitry 107 and cache 108), communication fabric 109, volatile memory 110, persistent storage 111 (including operating system 112 and block 125, as identified above), peripheral device set 113 (including user interface (UI) device set 114, storage 115, and Internet of Things (IoT) sensor set 116), and network module 117. Remote server 103 includes remote database 118. Public cloud 104 includes gateway 119, cloud orchestration module 120, host physical machine set 121, virtual machine set 122, and container set 123.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 118. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 106 includes one, or more, computer processors of any type now known or to be developed in the future. Processing circuitry 107 may be distributed over multiple packages, for example, multiple, coordinated integrated circuit chips. Processing circuitry 107 may implement multiple processor threads and/or multiple processor cores. Cache 108 is memory that is located in the processor chip package(s) and is typically used for data or code that should be available for rapid access by the threads or cores running on processor set 106. Cache memories are typically organized into multiple levels depending upon relative proximity to the processing circuitry. Alternatively, some, or all, of the cache for the processor set may be located “off chip.” In some computing environments, processor set 106 may be designed for working with qubits and performing quantum computing.

Computer readable program instructions are typically loaded onto computer 101 to cause a series of operational steps to be performed by processor set 106 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 108 and the other storage media discussed below. The program instructions, and associated data, are accessed by processor set 106 to control and direct performance of the inventive methods. In computing environment 100, at least some of the instructions for performing the inventive methods may be stored in block 125 in persistent storage 111.

Communication fabric 109 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 110 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 110 is located in a single package and is internal to computer 101, but, alternatively or additionally, the volatile memory may be distributed over multiple packages and/or located externally with respect to computer 101.

Persistent Storage 111 is any form of non-volatile storage for computers that is now known or to be developed in the future. The non-volatility of this storage means that the stored data is maintained regardless of whether power is being supplied to computer 101 and/or directly to persistent storage 111. Persistent storage 111 may be a read only memory (ROM), but typically at least a portion of the persistent storage allows writing of data, deletion of data and re-writing of data. Some familiar forms of persistent storage include magnetic disks and solid state storage devices. Operating system 112 may take several forms, such as various known proprietary operating systems or open source Portable Operating System Interface type operating systems that employ a kernel. The code included in block 125 typically includes at least some of the computer code involved in performing the inventive methods.

Peripheral device set 113 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (for example, secure digital (SD) card), connections made though local area communication networks and even connections made through wide area networks such as the internet. In various embodiments, UI device set 114 may include components such as a display screen, speaker, microphone, wearable devices (such as goggles and smart watches), keyboard, mouse, printer, touchpad, game controllers, and haptic devices. Storage 115 is external storage, such as an external hard drive, or insertable storage, such as an SD card. Storage 115 may be persistent and/or volatile. In some embodiments, storage 115 may take the form of a quantum computing storage device for storing data in the form of qubits. In embodiments where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 116 is made up of sensors that can be used in Internet of Things applications. For example, one sensor may be a thermometer and another sensor may be a motion detector.

Network module 117 is the collection of computer software, hardware, and firmware that allows computer 101 to communicate with other computers through WAN 124. Network module 117 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 117 are performed on the same physical hardware device. In other embodiments (for example, embodiments that utilize software-defined networking (SDN)), the control functions and the forwarding functions of network module 117 are performed on physically separate devices, such that the control functions manage several different network hardware devices. Computer readable program instructions for performing the inventive methods can typically be downloaded to computer 101 from an external computer or external storage device through a network adapter card or network interface included in network module 117.

WAN 124 is any wide area network (for example, the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 102 is any computer system that is used and controlled by an end user (for example, a customer of an enterprise that operates computer 101), and may take any of the forms discussed above in connection with computer 101. EUD 102 typically receives helpful and useful data from the operations of computer 101. For example, in a hypothetical case where computer 101 is designed to provide a recommendation to an end user, this recommendation would typically be communicated from network module 117 of computer 101 through WAN 124 to EUD 102. In this way, EUD 102 can display, or otherwise present, the recommendation to an end user. In some embodiments, EUD 102 may be a client device, such as thin client, heavy client, mainframe computer, desktop computer and so on.

Remote server 103 is any computer system that serves at least some data and/or functionality to computer 101. Remote server 103 may be controlled and used by the same entity that operates computer 101. Remote server 103 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 118 of remote server 103.

Public cloud 104 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 104 is performed by the computer hardware and/or software of cloud orchestration module 120. The computing resources provided by public cloud 104 are typically implemented by virtual computing environments that run on various computers making up the computers of host physical machine set 121, which is the universe of physical computers in and/or available to public cloud 104. The virtual computing environments (V CEs) typically take the form of virtual machines from virtual machine set 122 and/or containers from container set 123. It is understood that these VCEs may be stored as images and may be transferred among and between the various physical machine hosts, either as images or after instantiation of the VCE. Cloud orchestration module 120 manages the transfer and storage of images, deploys new instantiations of VCEs and manages active instantiations of VCE deployments. Gateway 119 is the collection of computer software, hardware, and firmware that allows public cloud 104 to communicate through WAN 124.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 105 is similar to public cloud 104, except that the computing resources are only available for use by a single enterprise. While private cloud 105 is depicted as being in communication with WAN 124 in other embodiments a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 104 and private cloud 105 are both part of a larger hybrid cloud.

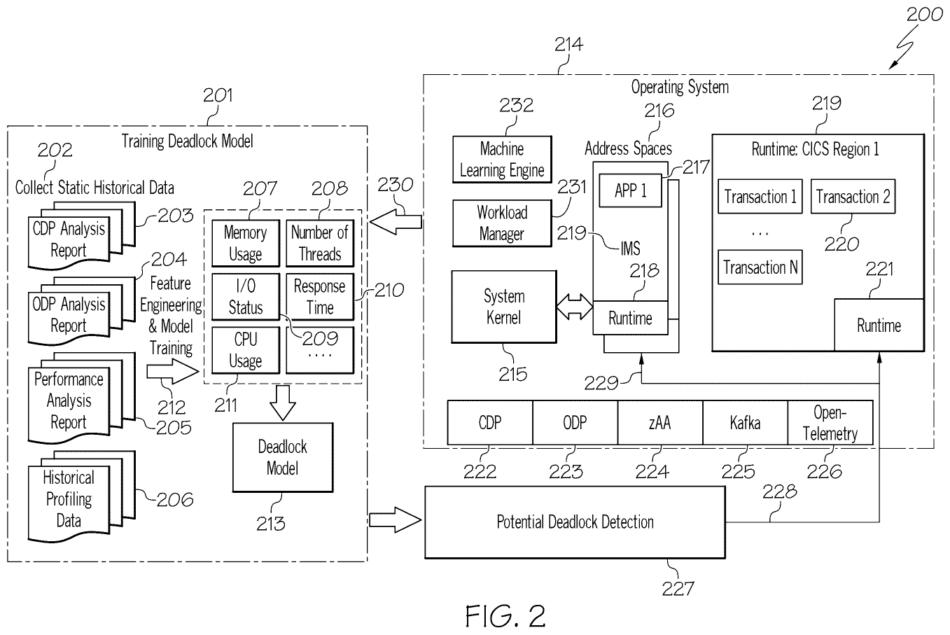

Block 125 further includes the software components discussed herein in connection with FIGS. 2-5, 6A-6B and 7-10 to effectively detect and resolve deadlocks in data concurrent processing systems. In one embodiment, such components may be implemented in hardware. The functions discussed herein performed by such components are not generic computer functions. As a result, computer 101 is a particular machine that is the result of implementing specific, non-generic computer functions.

In one embodiment, the functionality of such software components of computer 101, including effectively detecting and resolving deadlocks in data concurrent processing systems, may be embodied in an application specific integrated circuit.

An embodiment of computer 101 (FIG. 1) implementing the system architecture for detecting and resolving deadlocks in data concurrent processing systems is discussed below in connection with FIG. 2.

FIG. 2 illustrates a system architecture 200 for detecting and resolving deadlocks in data concurrent processing systems in accordance with an embodiment of the present disclosure.

As shown in FIG. 2, system architecture 200 includes the aspect of training a deadlock model (see element 201). A deadlock model, as used herein, refers to a model trained to detect potential deadlocks in data concurrent processing systems. In one embodiment, the deadlock model is trained to detect potential deadlocks using collected static historical data 202, such as common data provider (CDP) analysis reports 203, omegamon data provider (ODP) analysis reports 204, performance analysis reports 205, and historical profiling data 206.

CDP analysis reports 203, as used herein, refer to reports that focus on customer behavior and segmentation, including purchase history, website activity, app usage, campaign engagement, lifetime value, churn risk, and customer acquisition costs.

ODP analysis reports 204, as used herein, refer to performance data collected by monitoring agents on a system (e.g., z/OS system) to external analytics platforms, e.g., Splunk®.

Performance analysis reports 205, as used herein, detail the efficiency and effectiveness of a system designed to handle multiple data operations simultaneously.

Historical profiling data 206, as used herein, refers to data gathered over time that details the performance characteristics of various processes running concurrently within the system allowing for analysis of trends, bottlenecks, and potential optimization opportunities related to how multiple tasks execute simultaneously.

In one embodiment, in connection with such collected static historical data 202, various features are tracked over time as part of such historical data 202, including memory usage 207, number of threads 208, input/output (I/O) status 209, response time 210, processor (e.g., central processor unit (CPU)) usage 211, etc. By tracking such features, trends and patterns in how much memory, thread usage, I/O status (current state of a computer's input/output operations), response time (time to react to a request and respond), processor usage, etc. can be identified and used for detecting potential deadlocks. For example, based on the analysis of collected static historical data 202, a potential deadlock may be deemed to occur in response to having multiple threads, a response time that is twice more than normal, a transaction per second rate that is greater than a designated threshold, a processor usage that is greater than a designated threshold (90% of processor's capacity being utilized at a given time), and a memory usage that is greater than a designated threshold (e.g., 90% of memory in use relative to the total available memory).

In one embodiment, feature engineering tools or methods are utilized to extract related features (e.g., processor usage exceeds a designated threshold, memory usage exceeds a designated threshold, response time twice the normal response time, etc.) and analyzed to determine when deadlocks occur. Referring to the above example, based on such an analysis, a potential deadlock may be deemed to occur in response to having multiple threads, a response time that is twice more than normal, a transaction per second rate that has declined greater than a designated threshold, a processor usage that is greater than a designated threshold (90% of processor's capacity being utilized at a given time), and a memory usage that is greater than a designated threshold (e.g., 90% of memory in use relative to the total available memory).

In one embodiment, such identified features are extracted from collected static historical data 202 using feature engineering tools to determine when deadlocks occur and used to train the deadlock model as illustrated in element 212. An example of such a feature engineering tool is the Feature Engineering Library (Python® toolkit).

Based on identifying when deadlocks occur with the features selected, a model, such as a classification model (identified as “deadlock model” in FIG. 2) 213, is trained to predict potential deadlocks in data concurrent processing system based on such identified features meeting requirements (e.g., memory usage greater than a designated threshold, etc.). In one embodiment, various classification algorithms may be utilized to train classification model 213, such as support vector machine, decision tree, etc.

System architecture 200 further includes operating system 214 of computer 101, which includes system kernel 215, which corresponds to the core component of operating system 214 functioning as the primary interface between the hardware and software applications, managing vital functions, such as memory allocation, process scheduling, and file system access.

Furthermore, operating system 214 includes address spaces 216 corresponding to a range of memory addresses available for storing and retrieving data within computer 101. In one embodiment, address spaces 216 allocate a range of memory addresses to run applications 217 (e.g., “App 1”) and runtime 218 (portion of memory allocated and accessible to a program during its execution, where variables, data structures, and code are stored and accessed as needed). Furthermore, information management system (IM S) 219 operates within multiple separate address spaces, such as on the z/OS operating system, allowing different components of the IM S system to run independently and efficiently with each address space dedicated to a specific function (e.g., executing application programs).

Additionally, operating system 214 includes a CICS (customer information control system) region 219 (e.g., “CICS Region 1”), which includes a collection of resources that are controlled by CICS as a unit. A CICS resource is any facility or component of a CICS system that is required to perform a task. The resources in a region include programs, basic mapping support (BM S) map sets, transactions 220 (identified as “Transaction 1,” “Transaction 2,” . . . “Transaction N,” where N is a positive integer number, in FIG. 2), terminals, files, transient data queues, temporary storage queues, and journals.

In one embodiment, each CICS region 219 is defined (by a permanent region definition) with a list of resource groups with which it can be started. When CICS region 219 starts, resource definitions in the groups are loaded into CICS region 219 as runtime resource definitions (see runtime 221).

Additionally, system architecture 200 includes common data provider (CDP) data 222 (focus on customer behavior and segmentation), omegamon data provider (ODP) data 223 (performance data collected by monitoring agents on a system), z anomaly analytics (zAA) 224 (detects and groups anomalies within the z/OS system logs), Kafka 225 (event streaming platform allowing applications running on the mainframe to publish and consume real-time data streams), and OpenTelemetry 226 (framework enabling the collection and export of telemetry data, such as traces, metrics, and logs, from applications running on operating system 214).

As will be discussed in greater detail further below, in one embodiment, a potential deadlock event (see element 227) may be detected by deadlock classification model 213. When such an event occurs (see element 227), model 213 notifies the system (e.g., operating system 214) of the potential deadlock event (see element 228).

Upon receiving such a notification, operating system 214, such as workload manager 231 of operating system 214 (discussed further below), performs an action to resolve the potential deadlock (i.e., to prevent the potential deadlock from actually occurring). Upon performing such an action to resolve the potential deadlock, workload manager 231 determines if the system status returned to normal. If the system status does not return to normal, then workload manager 231 determines if a deadlock has actually occurred in the data processing system. In one embodiment, such a determination is performed by using the wait-for-graph approach involving a graphical representation of the systems' processes and resources, where a cycle in the graph indicates a deadlock. In another embodiment, such a determination is performed by using a resource allocation graph, where a cycle in the graph indicates a deadlock. In a further embodiment, such a determination is performed by detecting the occurrence of deadlock conditions based on logged information.

If a deadlock has occurred in the data concurrent processing system, then an action is performed to resolve the deadlock in runtime 218 (see element 229). Such an action does not require changing program source code or recompiling the program. In one embodiment, such an action involves identifying the thread which can be revoked with the mutex safely. A mutex (mutual exclusion) is a program object that prevents multiple threads (smaller unit of execution that exists within a process) from accessing the same shared resource simultaneously. The identified thread is then hung. That is, the identified thread is prevented from completing its task/job. The mutex from the identified thread is then released so that another thread can acquire the mutex to access the shared resource. The identified thread is then added to a queue to wait for the availability of the mutex. Once it becomes available, the identified thread acquires the mutex so that it can access the shared resource.

Furthermore, in one embodiment, a reward of the current action (i.e., the action that was performed) is calculated and used to refine the trained model (see element 230) via workload manager 231. Workload manager 231, as used herein, refers to a software tool that monitors and controls how system resources are allocated to different processes or applications running on the system. In one embodiment, workload manager 231 is the base component of the operating system (e.g., operating system 214), including z/OS. In a data concurrent processing system, a process, as used herein, refers to an individual unit of execution that can operate simultaneously with other processes allowing multiple tasks to work on data seemingly at the same time.

Additionally, as illustrated in FIG. 2, operating system 214 includes machine learning engine 232 configured to train model 213 to detect potential deadlocks in data concurrent processing systems based on a sample data set.

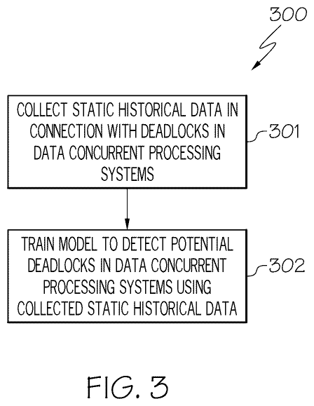

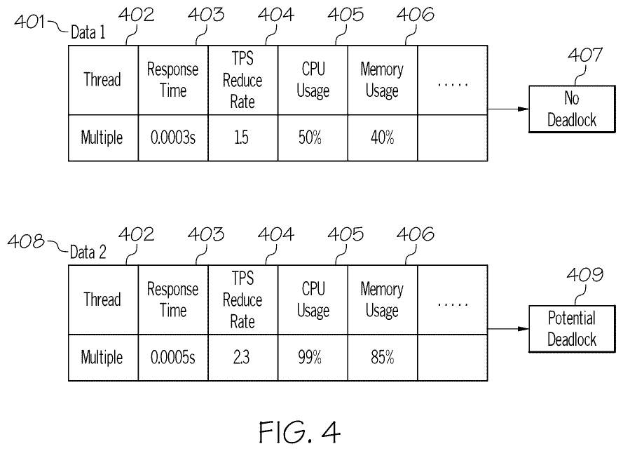

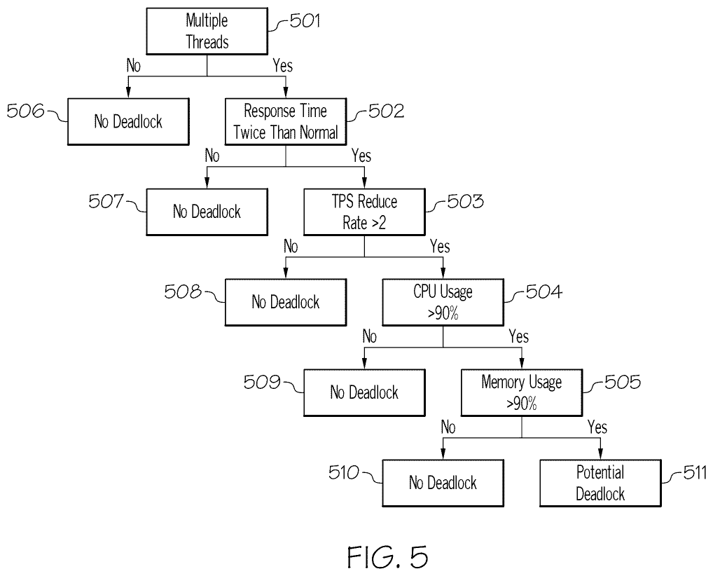

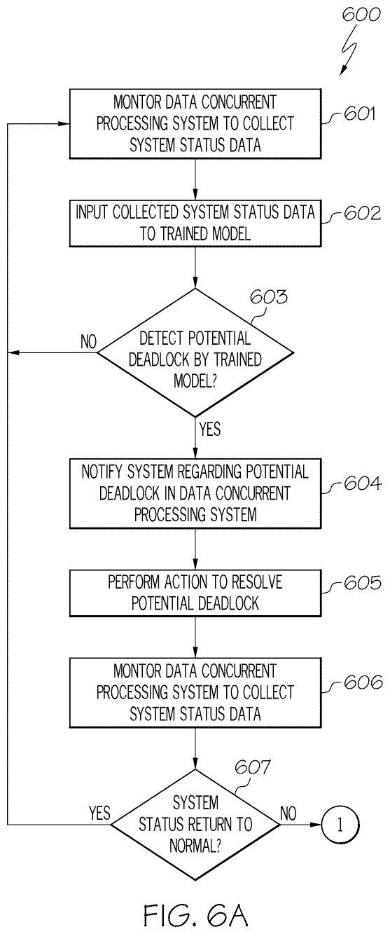

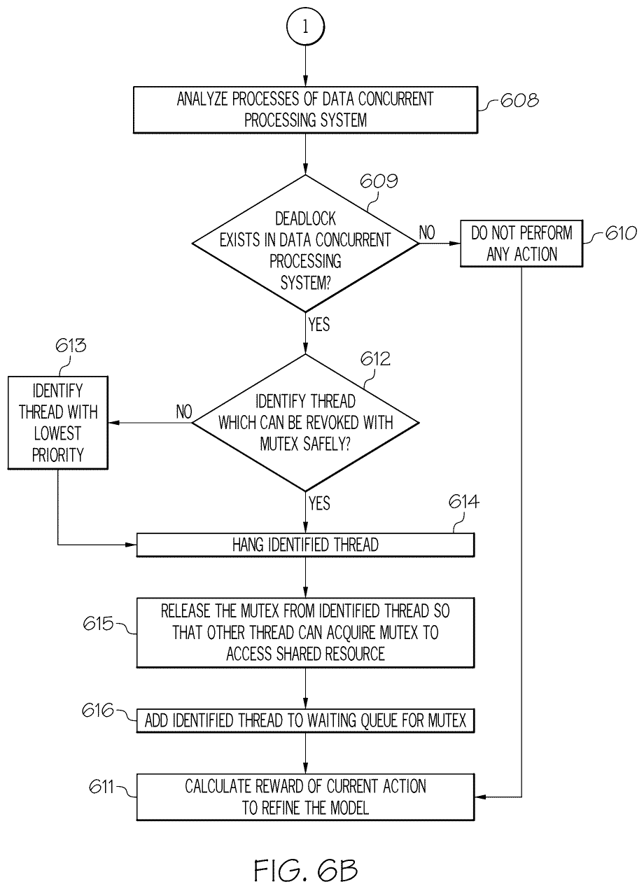

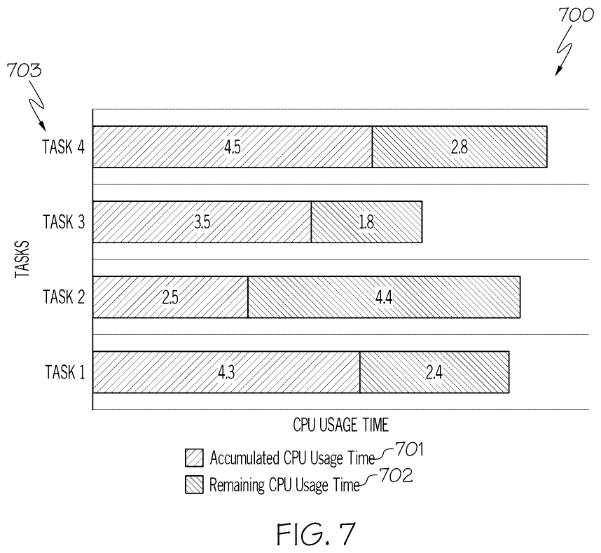

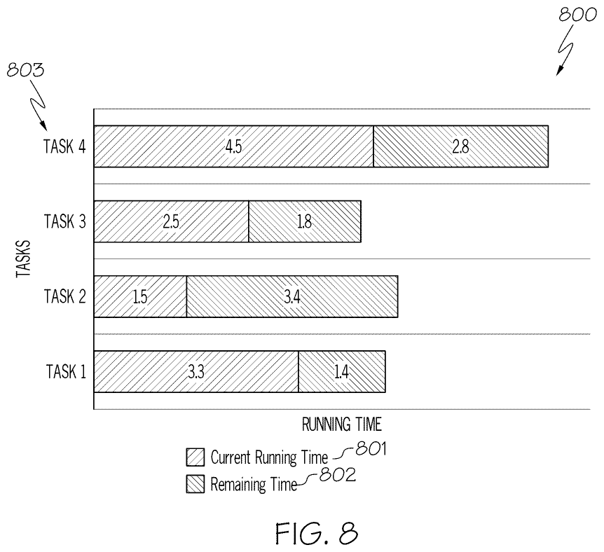

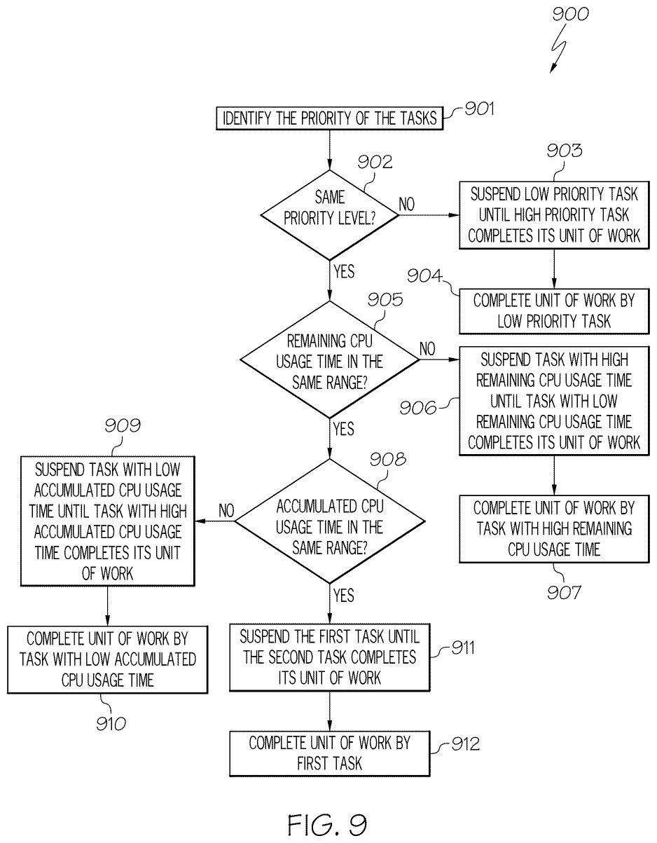

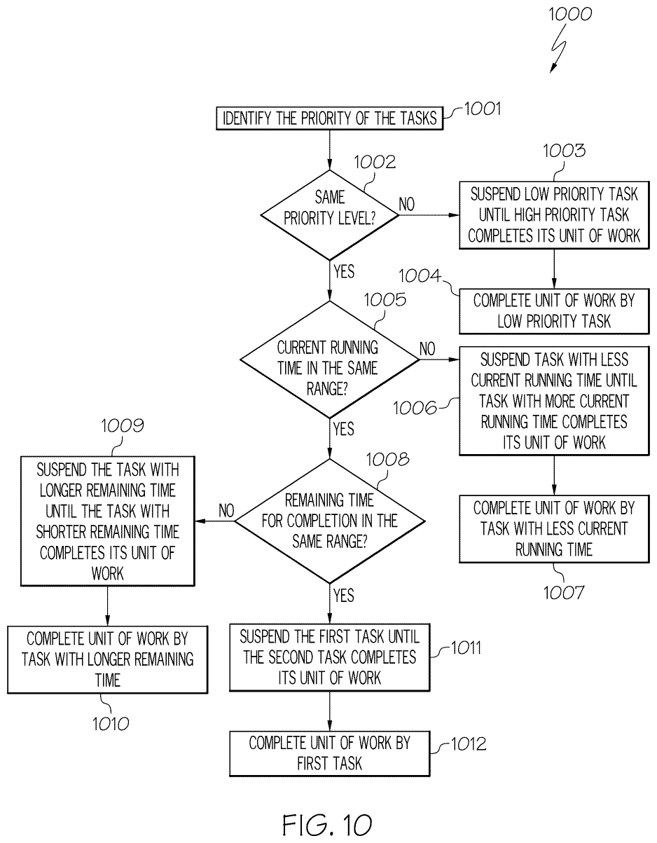

In this manner, deadlocks in data concurrent processing systems can be effectively detected and resolved. A further description of these and other features will be provided below in connection with FIGS. 3-5, 6A-6B, and 7-10. FIG. 3 is a flowchart of a method for training a model to detect potential deadlocks in data concurrent processing systems. FIG. 4 illustrates features of static historical data being utilized for detecting potential deadlocks. FIG. 5 illustrates training a model to detect potential deadlocks using a decision tree. FIGS. 6A-6B are a flowchart of a method for detecting and resolving deadlocks. FIG. 7 illustrates an exemplary central processor unit (CPU) usage status of various tasks being performed. FIG. 8 illustrates an exemplary running status of various tasks being performed. FIG. 9 is a flowchart of a method for resolving potential deadlocks based on processor usage. FIG. 10 is a flowchart of a method for resolving potential deadlocks based on running time.

As stated above, FIG. 3 is a flowchart of a method 300 for training a model to detect potential deadlocks in data concurrent processing systems in accordance with an embodiment of the present disclosure.

Referring to FIG. 3, in conjunction with FIGS. 1-2, in step 301, static historical data 202 is collected in connection with deadlocks in data concurrent processing systems.

As stated above, static historical data 202 includes data, such as common data provider (CDP) analysis reports 203, omegamon data provider (ODP) analysis reports 204, performance analysis reports 205, and historical profiling data 206.

In one embodiment, in connection with such collected static historical data 202, various features are tracked over time as part of such historical data 202, including memory usage 207, number of threads 208, input/output (I/O) status 209, response time 210, processor (e.g., CPU) usage 211, etc. By tracking such features, trends and patterns in memory usage, thread usage, I/O status (current state of a computer's input/output operations), response time (time to react to a request and respond), processor usage, etc. that are associated with deadlocks occurring are identified as illustrated in FIG. 4.

Referring to FIG. 4, FIG. 4 illustrates features of static historical data 202 being utilized for detecting potential deadlocks in accordance with an embodiment of the present disclosure.

As shown in FIG. 4, data from the collected static historical data 202, such as “Data 1” 401, indicates that thread 402 (thread, as used herein, refers to a smaller unit of execution that exists within a process) is multiple (i.e., the program is executing multiple threads), with a response time 403 (time to react to a request and respond) of 0.0003 seconds, a transaction per second (TPS) reduction rate 404 (a measure of the rate in the decline in the number of transactions a system can process within a single second) of 1.5, a processor (CPU) usage rate 405 (processor's capacity being utilized at a given time) of 50%, and a memory usage rate 406 (amount of memory in use relative to the total available memory) of 40%. Furthermore, the collected static historical data 202 indicated that a deadlock did not occur (see element 407). As a result, such data may be used to train model 213 to not indicate a potential deadlock based on the values for such features.

Furthermore, as shown in FIG. 4, data from the collected static historical data 202, such as “Data 2” 408, indicates that thread 402 is multiple (i.e., the program is executing multiple threads), with a response time 403 of 0.0005 seconds, a transaction per second (TPS) reduction rate 404 of 2.3, a processor (CPU) usage rate 405 of 99%, and a memory usage rate 406 of 85%. Furthermore, the collected static historical data 202 indicated that a deadlock did occur (see element 409). As a result, such data may be used to train model 213 to indicate a potential deadlock based on the values for such features.

Returning to FIG. 3, in conjunction with FIGS. 1-2 and 4, in step 302, machine learning engine 232 trains a model, such as model 213, to detect potential deadlocks in data concurrent system systems using the collected static historical data 202.

In one embodiment, feature engineering tools or methods are utilized to extract related features (e.g., processor usage exceeds a designated threshold, memory usage exceeds a designated threshold, response time twice the normal response time, etc.) and analyzed to determine when deadlocks occur. Referring to the above example, based on such an analysis, a potential deadlock may be deemed to occur in response to having multiple threads, a response time that is twice more than normal, a transaction per second reduction rate that is greater than a designated threshold, a processor usage that is greater than a designated threshold (90% of processor's capacity being utilized at a given time), and a memory usage that is greater than a designated threshold (e.g., 90% of memory in use relative to the total available memory).

As stated above, in one embodiment, such identified features are extracted from the collected static historical data 202 using feature engineering tools to determine when deadlocks occur and used to train the deadlock model as illustrated in element 212. An example of a feature engineering tool is the Feature Engineering Library (Python® toolkit).

In one embodiment, based on identifying when deadlocks occur with the features selected, a model, such as model 213, is trained to detect potential deadlocks in data concurrent processing systems based on such identified features meeting requirements (e.g., memory usage greater than a designated threshold, etc.). In one embodiment, various classification algorithms may be utilized to train model 213, such as support vector machine, decision tree, etc.

An example of training model 213 using a decision tree is provided in FIG. 5.

FIG. 5 illustrates training a model to detect potential deadlocks using a decision tree in accordance with an embodiment of the present disclosure.

As shown in FIG. 5, various features, such as a process with multiple threads (see element 501), a response time that is twice more than normal (see element 502), a transaction per second (TPS) reduction rate that exceeds a threshold value of 2 (signifying a reduction of 200%) (see element 503), a processor (CPU) usage rate that exceeds a threshold value of 90% (see element 504), and a memory usage rate that exceeds a threshold value of 90% (see element 505).

As further illustrated in FIG. 5, based on whether the values of such features are met, a determination as to whether a potential deadlock is detected is determined. For instance, if the process does not have multiple threads, then a deadlock is not detected (see element 506). If, however, the process does have multiple threads, then a determination is made as to whether the response time is twice more than normal (see element 502). If the response time is not twice more than normal, then a deadlock is not detected (see element 507). If, however, the response time is twice more than normal, then a determination is made as to whether the transaction per second (TPS) reduction rate exceeds a threshold value of 2 (see element 503). If the transaction per second (TPS) reduction rate does not exceed a threshold value of 2, then a deadlock is not detected (see element 508). If, however, the transaction per second (TPS) reduction rate does exceed a threshold value of 2, then a determination is made as to whether the processor (CPU) usage rate exceeds a threshold value of 90% (see element 504). If the processor (CPU) usage rate does not exceed a threshold value of 90% (see element 504), then a deadlock is not detected (see element 509). If, however, the processor (CPU) usage rate exceeds a threshold value of 90% (see element 504), then a determination is made as to whether the memory usage rate exceeds a threshold value of 90% (see element 505). If the memory usage rate does not exceed a threshold value of 90%, then a deadlock is not detected (see element 510). If, however, the memory usage rate exceeds the threshold value of 90%, then a potential deadlock is detected (see element 511).

In this manner, model 213 can be trained to detect potential deadlocks in data concurrent processing systems.

In another embodiment, model 213 is trained by machine learning engine 232 to detect potential deadlocks by analyzing the workloads and profiling data, such as data from SMF 30 applications. SMF 30, as used herein, refers to a type of record that contains job performance data. It tracks the start and end of jobs, tasks, and other work units. A workload, as used herein, refers to the amount of work or processing a system needs to complete a task or produce an output. Profiling data, as used herein, refers to data that has been examined, analyzed, reviewed, and summarized to gain insight into the quality of the data.

In one embodiment, perf (performance analyzing tool in Linux®) or eBPF (runs sandboxed programs in a privileged context, such as operating system kernel 215) are used to analyzed workloads.

In one embodiment, the current lock status is obtained for all the workloads, including information, such as the workload identifier, currently occupied resources, resource competition frequency (how often processes or threads encounter each other while competing for a limited resource), lock number (unique identifier assigned to a specific lock held by a transaction), lock mode (type of access a transaction is requesting on a resource, such as shared lock or exclusive lock, which determines whether a lock conflict can occur with another transaction), and resources that are waiting. In one embodiment, such information is obtained from workload manager 231.

In one embodiment, such information from the workloads and profiling data obtained from workload manager 231 is analyzed by machine learning engine 232 to determine when deadlocks occur, which is used to train model 213 to detect potential deadlocks.

In one embodiment, machine learning engine 232 trains model 213 to detect potential deadlocks in data concurrent processing systems based on a sample data set, which may include information, such as, but not limited to, the combination of values of features (e.g., a process with multiple threads, a response time that is twice more than normal, a transaction per second reduction rate that exceeds a threshold value of 2 (signifying a reduction of 200%), a processor (CPU) usage rate that exceeds a threshold value of 90%, a memory usage rate that exceeds a threshold value of 90%, etc.) that result in deadlocks. In one embodiment, such information (sample data set) is obtained from monitoring data concurrent processing systems by workload manager 231. In one embodiment, such a sample data set is populated by an expert.

Furthermore, in one embodiment, the sample data set discussed above is referred to herein as the “training data,” which is used by a machine learning algorithm to make predictions or decisions, such as predicting the detection of potential deadlocks in a data concurrent processing system based on system status data. System status data, as used herein, refers to information about the state of the system's hardware and software, which includes values of features, such as the number of threads, the response time, processor usage rate, memory usage rate, transaction per second reduction rate, etc. The algorithm iteratively makes predictions on the training data until the predictions achieve the desired accuracy as determined by an expert. Examples of such learning algorithms include nearest neighbor, Naïve Bayes, decision trees, linear regression, support vector machines, and neural networks.

A discussion regarding using the trained model (e.g., model 213) to detect potential deadlocks is provided below in connection with FIGS. 6A-6B.

FIGS. 6A-6B are a flowchart of a method 600 for detecting and resolving deadlocks in accordance with an embodiment of the present disclosure.

Referring to FIG. 6A, in conjunction with FIGS. 1-5, in step 601, workload manager 231 monitors the data concurrent processing system (e.g., system architecture 200 of computer 101) to collect system status data.

As discussed above, system status data, as used herein, refers to information about the state of the system's hardware and software, which includes values of features, such as the number of threads, the response time, processor usage rate, memory usage rate, transaction per second reduction rate, etc.

An example of such collected system status data is shown in FIG. 4, such as the number of threads 402, response time 403, the transaction per second (TPS) reduction rate 404, the processor (CPU) usage rate 405, and the memory usage rate 406.

In one embodiment, workload manager 231 monitors the data concurrent processing system to collect system data by utilizing built-in system monitoring tools, dedicated monitoring software, or custom scripts.

In step 602, workload manager 231 inputs the collected system status data to the trained model 213.

In step 603, model 213 determines whether a potential deadlock is detected based on the collected system status data.

As discussed above, model 213 is trained to detect potential deadlocks based on information, such as system status data, which includes values of features, such as the number of threads, the response time, processor usage rate, memory usage rate, transaction per second reduction rate, etc. If, for example, the values of such features meet such threshold values, as depicted in FIG. 5, then model 213 may deem that a potential deadlock has been detected.

If model 213 does not detect a potential deadlock, then workload manager 231 continues to monitor the data concurrent processing system (system architecture 200 of computer 101) to collect system status data in step 601.

If, however, model 213 detects a potential deadlock, then, in step 604, model 213 notifies the system (e.g., operating system 214) of the potential deadlock event (see element 228) in the data concurrent processing system (system architecture 200 of computer 101).

Upon receiving such a notification, in step 605, operating system 214, such as workload manager 231, performs an action to resolve the potential deadlock (i.e., to prevent the potential deadlock from actually occurring).

In one embodiment, operating system 214 attempts to resolve (i.e., prevent the deadlock from actually occurring) based on processor usage or running time. A discussion regarding resolving the potential deadlock based on processor usage is discussed below in connection with FIG. 9. A discussion regarding resolving the potential deadlock based on running time is discussed below in connection with FIG. 10.

As discussed above, in one embodiment, in connection with resolving the potential deadlock based on processor usage or running time, workload manager 231 analyzes the workload and profiling data. A workload, as used herein, refers to the amount of work or processing a system needs to complete a task or produce an output. Profiling data, as used herein, refers to data that has been examined, analyzed, reviewed, and summarized to gain insight into the quality of the data.

In one embodiment, the workload and profiling data includes data from SMF 30 applications. SMF 30, as used herein, refers to a type of record that contains job performance data. It tracks the start and end of jobs, tasks, and other work units.

In one embodiment, workload manager 231 utilizes perf (performance analyzing tool in Linux®) or eBPF (runs sandboxed programs in a privileged context, such as operating system kernel 215) to analyze the workloads.

In one embodiment, such information obtained from the workloads and profiling data includes task execution, such as start time, end time, processor (CPU) time used, wait time, data I/O volume, etc. In one embodiment, historical data, such as static historical data 202, is analyzed to determine how similar tasks have been performed in the past to obtain an average runtime, maximum and minimum runtime, resource usage, and system load of tasks (measuring how much computational work computer 101 is currently handling).

In one embodiment, a baseline for task execution time is established based on such an analysis. Such a baseline reflects the average execution time of tasks and takes into account the impact of system load.

In one embodiment, based on such analyzed data, the approximate completion time for tasks as well as the processor usage time of the task in the current system are predicted. That is, in one embodiment, based on such analyzed data, the accumulate processor (CPU) usage time as well as the remaining processor (CPU) usage time for various tasks or threads may be obtained as illustrated in FIG. 7.

Referring to FIG. 7, FIG. 7 illustrates an exemplary central processor unit (CPU) usage status 700 of various tasks being performed in accordance with an embodiment of the present disclosure.

As shown in FIG. 7, processor (CPU) usage status 700 includes the accumulated processor (CPU) usage time 701 and the remaining processor (CPU) usage time 702 for various tasks 703 (e.g., “Task 1,” “Task 2,” “Task 3,” and “Task 4,” as identified in FIG. 7). Accumulated processor (CPU) usage time 701, as used herein, refers to the total amount of time a processor has spent actively working on tasks. The remaining processor (CPU) usage time 702, as used herein, refers to the estimated amount of time a processor will continue to be actively used by currently running processes. Task 703, as used herein, refers to a single unit of work or execution within a system. In one embodiment, accumulated CPU usage time 701 is obtained from profiling data. In one embodiment, the remaining CPU usage time 702 is computed by subtracting the accumulated CPU usage time 701 from the approximate CPU usage time of the task, which is obtained from the history data of workload manager 231.

Furthermore, in one embodiment, based on the analyzed data discussed above, the running time and the remaining time for various tasks or threads may be obtained as illustrated in FIG. 8.

Referring to FIG. 8, FIG. 8 illustrates an exemplary running status 800 of various tasks being performed in accordance with an embodiment of the present disclosure.

As shown in FIG. 8, running status 800 includes the current running time 801 and the remaining time 802 for various tasks 803 (e.g., “Task 1,” “Task 2,” “Task 3,” and “Task 4,” as identified in FIG. 8). Current running time 801, as used herein, refers to the current amount of time that a task has been running to complete its job. Remaining time 802, as used herein, refers to the amount of time that is left for the task to complete its job. Task 803, as used herein, refers to a single unit of work or execution within a system. In one embodiment, current running time 801 is obtained from profiling data. In one embodiment, remaining time 802 is computed by subtracting current running time 801 from the approximate completion time of the task, which is obtained from the history data of workload manager 231.

A discussion regarding resolving the potential deadlock based on processor usage is provided below in connection with FIG. 9.

FIG. 9 is a flowchart of a method 900 for resolving potential deadlocks based on processor usage in accordance with an embodiment of the present disclosure.

Referring to FIG. 9, in conjunction with FIGS. 1-5, 6A and 7, in step 901, workload manager 231 identifies the priority of the tasks involved in the potential deadlock. For example, multiple tasks (e.g., task 1 and task 2) may each be waiting for the other task to release a lock in order for the task to access a shared resource.

A task, as used herein, refers to a single unit of work or execution. In one embodiment, workload manager 231 maintains the priority of the tasks being performed. In one embodiment, tasks are assigned a priority level via “priority scheduling,” where operating system 214 uses algorithms to determine the importance of each task allowing the most critical tasks to be executed first by assigning numerical priority values, where the higher numbers represent higher priority tasks.

In step 902, workload manager 231 determines whether the priority of the tasks (e.g., task 1, task 2) involved in the potential deadlock are at the same priority level. The “same priority level,” as used herein, refers to having the priorities of the tasks in question being within a user-designated threshold amount of difference. For example, if the difference between the priority level of task 1 and the priority level of task 2 is less than a user-designated threshold value, then such tasks are deemed to be at the same priority level.

If the tasks are not deemed to be at the same priority level, then, in step 903, workload manager 231 suspends the lower priority task until the higher priority task completes its unit of work. That is, a first task is suspended until the second task completes its unit of work in response to the priority being assigned to the first task being lower than the priority assigned to the second task by a threshold amount.

In step 904, the lower priority task completes its unit of work upon the higher priority task completing its unit of work.

If, however, the tasks are deemed to be at the same priority level, then, in step 905, workload manager 231 determines whether the remaining processor (CPU) usage time, such as remaining CPU usage time 702, for the tasks involved in the potential deadlock are in the same range. The “same range” in connection with the remaining processor (CPU) usage time, as used herein, refers to having the remaining processor (CPU) usage time of the tasks in question being within a user-designated threshold amount of difference. For example, if the difference between the remaining processor (CPU) usage time of task 1 and the remaining processor (CPU) usage time of task 2 is less than a user-designated threshold value, then such tasks are deemed to have the remaining processor (CPU) usage time within the same range.

If the remaining processor (CPU) usage time for the tasks involved in the potential deadlock are not in the same range, then, in step 906, workload manager 231 suspends the task with the high remaining processor (CPU) usage time until the task with the low remaining processor (CPU) usage time completes its unit of work. That is, a first task is suspended until the second task completes its unit of work in response to the remaining processor usage time of the first task exceeding the remaining processor usage time of the second task by a threshold amount.

In step 907, the task with the high remaining processor (CPU) usage time completes its unit of work upon the task with the low remaining processor (CPU) usage time completing its unit of work.

If, however, the remaining processor (CPU) usage time for the tasks involved in the potential deadlock are in the same range, then, in step 908, workload manager 231 determines whether the accumulated processor (CPU) usage time, such as the accumulated CPU usage time 701, for the tasks involved in the potential deadlock are in the same range. The “same range” in connection with the accumulated processor (CPU) usage time, as used herein, refers to having the accumulated processor (CPU) usage time of the tasks in question being within a user-designated threshold amount of difference. For example, if the difference between the accumulated processor (CPU) usage time of task 1 and the accumulated processor (CPU) usage time of task 2 is less than a user-designated threshold value, then such tasks are deemed to have the accumulated processor (CPU) usage time within the same range.

If the accumulated processor (CPU) usage time for the tasks involved in the potential deadlock are not in the same range, then, in step 909, workload manager 231 suspends the task with the low accumulated processor (CPU) usage time until the task with the high accumulated processor (CPU) usage time completes its unit of work. That is, a first task is suspended until the second task completes its unit of work in response to the accumulated processor usage time of the first task being less than the accumulated processor usage time of the second task by a threshold amount.

In step 910, the task with the low accumulated processor (CPU) usage time completes its unit of work upon the task with the high accumulated processor (CPU) usage time completing its unit of work.

If, however, the accumulated processor (CPU) usage time for the tasks involved in the potential deadlock are in the same range, then, in step 911, workload manager 231 suspends the first task until the second task completes its unit of work.

In step 912, the first task completes its unit of work upon the second task completing its unit of work.

A discussion regarding resolving the potential deadlock based on running time is provided below in connection with FIG. 10.

FIG. 10 is a flowchart of a method 1000 for resolving potential deadlocks based on running time in accordance with an embodiment of the present disclosure.

Referring to FIG. 10, in conjunction with FIGS. 1-5, 6A and 8, in step 1001, workload manager 231 identifies the priority of the tasks involved in the potential deadlock. For example, multiple tasks (e.g., task 1 and task 2) may each be waiting for the other task to release a lock in order for the task to access a shared resource.

As discussed above, in one embodiment, workload manager 231 maintains the priority of the tasks being performed. In one embodiment, tasks are assigned a priority level via “priority scheduling,” where operating system 214 uses algorithms to determine the importance of each task allowing the most critical tasks to be executed first by assigning numerical priority values, where the higher numbers represent higher priority tasks.

In step 1002, workload manager 231 determines whether the priority of the tasks (e.g., task 1, task 2) involved in the potential deadlock are at the same priority level. The “same priority level,” as used herein, refers to having the priorities of the tasks in question being within a user-designated threshold amount of difference. For example, if the difference between the priority level of task 1 and the priority level of task 2 is less than a user-designated threshold value, then such tasks are deemed to be at the same priority level.

If the tasks are not deemed to be at the same priority level, then, in step 1003, workload manager 231 suspends the lower priority task until the higher priority task completes its unit of work. That is, a first task is suspended until the second task completes its unit of work in response to the priority being assigned to the first task being lower than the priority assigned to the second task by a threshold amount.

In step 1004, the lower priority task completes its unit of work upon the higher priority task completing its unit of work.

If, however, the tasks are deemed to be at the same priority level, then, in step 1005, workload manager 231 determines whether the running time, such as current running time 801, for the tasks involved in the potential deadlock are in the same range. The “same range” in connection with the current running time, as used herein, refers to having the current running time of the tasks in question being within a user-designated threshold amount of difference. For example, if the difference between the current running time of task 1 and the current running time of task 2 is less than a user-designated threshold value, then such tasks are deemed to have the current running time within the same range.

If the current running time for the tasks involved in the potential deadlock are not in the same range, then, in step 1006, workload manager 231 suspends the task with less current running time until the task with more current running time completes its unit of work. That is, a first task is suspended until the second task completes its unit of work in response to the current running time of the first task being less than the current running time of the second task by a threshold amount.

In step 1007, the task with less current running time completes its unit of work upon the task with more current running time completing its unit of work.

If, however, the current running time for the tasks involved in the potential deadlock are in the same range, then, in step 1008, workload manager 231 determines whether the remaining time for completion, such as remaining time 802, for the tasks involved in the potential deadlock are in the same range. The “same range” in connection with the remaining time for completion, as used herein, refers to having the remaining time of the tasks in question being within a user-designated threshold amount of difference. For example, if the difference between the remaining time of task 1 and the remaining time of task 2 is less than a user-designated threshold value, then such tasks are deemed to have the remaining time for completion within the same range.

If the remaining time for completion for the tasks involved in the potential deadlock are not in the same range, then, in step 1009, workload manager 231 suspends the task with the longer remaining completion time until the task with the shorter remaining completion time completes its unit of work. That is, a first task is suspended until the second task completes its unit of work in response to the remaining completion time of the first task exceeding the remaining completion time of the second task by a threshold amount.

In step 1010, the task with the longer remaining completion time completes its unit of work upon the task with the shorter remaining completion time completing its unit of work.

If, however, the remaining time for completion for the tasks involved in the potential deadlock are in the same range, then, in step 1011, workload manager 231 suspends the first task until the second task completes its unit of work.

In step 1012, the first task completes its unit of work upon the second task completing its unit of work.

Returning to FIG. 6A, after performing an action to resolve the potential deadlock, such as discussed above in connection with FIGS. 7-10, in step 606, workload manager 231 monitors the data concurrent processing system (e.g., system architecture 200 of computer 101) to collect system status data to determine if the system status returned to normal. The system status is deemed to be returned to normal when the potential deadlock has been resolved thereby enabling the data concurrent processing system to function properly and be in its standard state allowing concurrent data access and processing without errors or disruption.

As discussed above, system status data, as used herein, refers to information about the state of the system's hardware and software, which includes values of features, such as the number of threads, the response time, processor usage rate, memory usage rate, transaction per second reduction rate, etc.

In one embodiment, workload manager 231 monitors the data concurrent processing system to collect system data by utilizing built-in system monitoring tools, dedicated monitoring software, or custom scripts.

In step 607, workload manager 231 determines whether the system status has returned to normal.

If the system status has returned to normal, then workload manager 231 continues to monitor the data concurrent processing system (e.g., system architecture 200 of computer 101) to collect system status data in step 601.

Referring to FIG. 6B, in conjunction with FIGS. 1-5 and 7-10, if, however, the system status has not returned to normal, then, in step 608, workload manager 231 analyzes the processes of the data concurrent processing system. As discussed above, a process of a data concurrent processing system, as used herein, refers to an individual unit of execution that can operate simultaneously with other processes allowing multiple tasks to work on data seemingly at the same time.

In one embodiment, such an analysis involves examining how multiple processes within the data concurrent processing system are interacting with each other to determine if any of them are stuck waiting for a resource that another process is holding.

In one embodiment, workload manager 231 analyzes the processes of the data concurrent process to examine how multiple processes within the data concurrent processing system are interacting with each other using various software tools, such as system monitoring tools (e.g., Datadog®, Splunk®, LogicMonitor®, etc.) to track process states and resource usage as well as debugging tools (e.g., Visual Studio®, PyCharm®, Valgrind) to analyze code execution flow and potential synchronization issues.

In step 609, workload manager 231 determines if a deadlock exists in the data concurrent processing system based on the analysis performed in step 608.

In one embodiment, workload manager 231 determines if a deadlock exists by creating a resource allocation graph which indicates the relationships between the processes and the resources, where a cycle in the graph indicates a deadlock. In one embodiment, workload manager 231 uses an algorithm (e.g., Depth-First Search (DFS)) to traverse the resource allocation graph and detect such cycles.

In one embodiment, workload manager 231 determines if a deadlock exists by using the wait-for-graph approach involving a graphical representation of the system's processes and resources, where a cycle in the graph indicates a deadlock. In such an embodiment, a directed graph is used to represent the relationships between processes and the resources they are waiting for, where a cycle in the graph indicates a deadlock. Furthermore, in such an embodiment, each process involved in resource allocation is represented as a node in the graph. Furthermore, a directed edge from one process to another process indicates that the first process is currently waiting for a resource held by the second process. A deadlock is then detected when a cycle exists in the wait-for-graph, which indicates that a group of processes are waiting for resources held by each other in a circular fashion.

In a further embodiment, workload manager 231 determines if a deadlock exists by detecting the occurrence of deadlock conditions based on logged information. In one embodiment, workload manager 231 analyzes the system logs to identify patterns that indicate the presence of deadlock conditions: mutual exclusion, hold and wait, no preemption, and circuit wait. In one embodiment, workload manager 231 utilizes log analysis tools, such as Datadog®, Sumo Logic®, Logstash®, etc. to analyze system logs in such a manner.

If a deadlock does not exist in the data concurrent processing system, then, in step 610, workload manager 231 does not perform any action.

In step 611, workload manager 231 calculates a reward of the current action (i.e., the action that was performed), which is used to refine the trained model (model 213) (see element 230).

In one embodiment, workload manger 231 assesses how good the action that was taken by assigning a numerical “reward” value, which is used as feedback to adjust the parameters of model 213. By analyzing the reward received, model 213 updates its internal parameters to increase the likelihood of taking actions that lead to higher rewards in the future. In one embodiment, workload manager 231 defines a reward function that assigns a numerical value to each possible action depending on its outcome in the current state by considering factors, such as how close the action results in achieving the desired goal, potential penalties for undesirable actions, and the immediate impact on the environment.

If, however, a deadlock exists in the data concurrent processing system, then an action is performed to resolve the deadlock as discussed below in connection with steps 612-616. In one embodiment, such an action is resolved within runtime 218. In this manner, changing the program source code or recompiling the program is not required.

In step 612, runtime 218 determines if a thread (thread from the processes involved in the deadlock) can be revoked with the mutex (lock) safely. That is, runtime 218 determines if it can identify a thread (thread from the processes involved in the deadlock) which can be revoked with the mutex from accessing the same shared resource safely. Revoking, as used herein, refers to preventing the thread from accessing the shared resource. In one embodiment, a first thread is revoked with a mutex safely if the first thread uses more time than the second thread (competitor thread) (thread competing for the same shared resource) to complete its job, and both threads (first and second threads) will be able to complete their assigned jobs on time after the first thread is revoked and later grated access to the mutex to access the shared resource.

A thread, as used herein, refers to a smaller unit of execution that exists within a process. A mutex (mutual exclusion), as used herein, refers to a program object that prevents multiple threads (smaller unit of execution that exists within a process) from accessing the same shared resource simultaneously. That is, a mutex is a mutual exclusion lock. In one embodiment, the mutex in operating system 214 is implemented by MCS (Mellor-Crummey and Scott) OSQ (optimistic spinning queue).

In one embodiment, a lock, such as a mutual exclusion lock (identified as lock x), to a particular thread (identified as thread i) will be revoked if the following conditions hold true:
1. Duration [T(i)L(x)]>Duration [T(j)L(x)], which is: [(End(Ti,Lx)−Start(Ti,Lx))−(End(Tj,Lx)−Start(Tj,Lx))]>0 Note: For lock x, thread i uses more time than thread j.
And
2. [(End(Ti,Lx)−Start(Ti,Lx))−(End(Tj,Lx)−Start (Tj,Lx)}]/(End (Ti,Lx)−Start (Ti,Lx))+(End(Tj,Lx)−Start(Tj,Lx))>P Note: Thread i will use significant time compared to thread j.
And
3.

$$Current\_time + \frac{1}{n} {\sum }_{k = 0}^{n} [ End ( Ti ) - Start ( Ti ) ] < time\_limit ( Ti ) * S$$

Note: If thread i is revoked for lock x, the whole process will complete on time safely.

In one embodiment, S corresponds to the safety threshold time limit for the whole job, which corresponds to an allotted time limit to complete the job. If the job exceeds such a threshold time limit, then the job will fail. In one embodiment, the safety threshold time limit value for the whole job, S, is S ∈ (0,1), which means that the whole job is considered to be safe when the whole job is finished within the time_limit*S.

P corresponds to the competitive thread. That is, P corresponds to the thread that is simultaneously waiting for a resource currently held by another thread. The threshold value for the competitive threads, P, is P ∈ (0,1), which means that the competitive thread may be granted with the competitive lock (mutex) if:

[(End(Tj,Lx)−Start(Tj,Lx))]/[(End(Ti,Lx)−Start(Ti,Lx))+(End(Tj,Lx)−Start(Tj,Lx))]<P

In one embodiment, the values of S and P can be determined by a domain expert or calculated using an artificial intelligence method.

If a thread cannot be identified to be revoked with the mutex safely, then, in step 613, runtime 218 identifies the thread with the lowest priority.

In one embodiment, runtime 218 identifies the thread among the threads of the processes involved in the deadlock with the lowest priority from workload manager 231. In one embodiment, workload manager 231 maintains the priority of the threads being performed. In one embodiment, threads are assigned a priority level via “priority scheduling,” where operating system 214 uses algorithms to determine the importance of each thread allowing the most critical threads to be executed first by assigning numerical priority values, where the higher numbers represent higher priority threads.

In step 614, after identifying a thread which can be revoked with a mutex safely or after identifying the thread with the lowest priority, runtime 218 hangs the identified thread. That is, runtime 218 prevents the identified thread from completing its task/job, such as by causing the thread to cease to respond to inputs. In one embodiment, runtime 218 hangs a thread by putting the thread in a waiting state where it cannot proceed with execution until a condition is met, such as the availability of the mutex as discussed further below.

In step 615, runtime 218 releases the mutex from the identified thread so that another thread can acquire the mutex to access the shared resource. For example, by releasing the mutex from the identified thread, the competitor thread (thread competing for the same shared resource) will now be granted access to the mutex to access the shared resource.

In step 616, runtime 218 adds the identified thread to a queue to wait for the availability of the mutex, which was acquired by the competitor thread. Once the mutex becomes available, the identified thread acquires the mutex so that it can access the shared resource.

In one embodiment, workload manager 231 then calculates a reward of the current action, such as the action that was performed in steps 612-616, in step 611, which is then used to refine the trained model (model 213) (see element 230).

As stated above, in one embodiment, workload manger 231 assesses how good the action that was taken by assigning a numerical “reward” value, which is used as feedback to adjust the parameters of model 213. By analyzing the reward received, model 213 updates its internal parameters to increase the likelihood of taking actions that lead to higher rewards in the future. In one embodiment, workload manager 231 defines a reward function that assigns a numerical value to each possible action depending on its outcome in the current state by considering factors, such as how close the action results in achieving the desired goal, potential penalties for undesirable actions, and the immediate impact on the environment.

As a result the foregoing, the principles of the present disclosure effectively detect and resolve deadlocks in data concurrent processing systems.

Furthermore, the principles of the present disclosure improve the technology or technical field involving data concurrent processing systems.

As discussed above, in a data concurrent processing system, a “deadlock” occurs when two or more processes are stuck waiting for each other to release resources they need to proceed thereby creating a circular dependency where none of the processes can move forward. For example, a deadlock occurs when each process holds a lock on a resource that another process needs to access resulting in a standstill where no progress can be made. As a result, each process ends up waiting for the other to release the lock. Consequently, the system becomes halted due to this mutual waiting situation. Attempts have been made to prevent and/or resolve deadlocks. For example, a specific order for acquiring resources may be enforced thereby ensuring that the processes always acquire locks in the same sequence. Unfortunately, such a technique significantly reduces system efficiency by imposing strict rules on resource acquisition. Another example in attempting to prevent and/or resolve deadlocks is to set timeouts on lock acquisition attempts thereby allowing a process to release a lock and retry if it is unable to acquire the required resource within a specified time. Unfortunately, such a technique may result in process starvation, where a process might be prematurely terminated or significantly delayed if it cannot acquire a necessary resource within the allotted time frame even if the resource eventually becomes available potentially leading to system inefficiency and data loss in critical situations. A further example in attempting to prevent and/or resolve deadlocks is to implement proper transaction management techniques to handle locking and ensure that transactions are properly committed or rolled back to avoid deadlocks. Unfortunately, such a technique may result in a decrease in system performance as acquiring and releasing locks can add overhead to operations, especially in high-concurrency scenarios where many processes are competing for access to data potentially leading to wait times and impacting responsiveness. As a result, there is not currently an effective means for detecting and resolving deadlocks in data concurrent processing systems.

Embodiments of the present disclosure improve such technology by training a model to detect potential deadlocks in data concurrent processing systems using collected static historical data (e.g., common data provider (CDP) analysis reports, omegamon data provider (ODP) analysis reports, performance analysis reports, historical profiling data, etc.) on data concurrent processing systems. After training such a model to detect potential deadlocks, a data concurrent processing system is monitored to collect system status data. System status data, as used herein, refers to information about the state of the system's hardware and software. Based on the collected system status data, the trained model determines if a potential deadlock has been detected. If a potential deadlock has been detected, then an action to resolve the potential deadlock is performed. In one embodiment, the potential deadlock is attempted to be resolved (i.e., preventing the deadlock from actually occurring) based on processor usage or running time. In this manner, deadlocks in data concurrent processing systems can be effectively detected and resolved. Furthermore, in this manner, there is an improvement in the technical field involving data concurrent processing systems.

The descriptions of the various embodiments of the present disclosure have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A computer-implemented method for detecting and resolving deadlocks, the method comprising:
training a model to detect potential deadlocks in data concurrent processing systems using collected static historical data;
monitoring a data concurrent processing system to collect system status data;
detecting a potential deadlock in said data concurrent processing system by said trained model using said collected system status data; and
performing an action to resolve said potential deadlock.

2. The method as recited in claim 1 further comprising:
identifying a priority of a first task and a second task involved in said potential deadlock;
suspending said first task until said second task completes its unit of work in response to said priority being assigned to said first task being lower than said priority assigned to said second task by a first threshold amount;
suspending said first task until said second task completes its unit of work in response to a remaining processor usage time of said first task exceeding said remaining processor usage time of said second task by a second threshold amount; and
suspending said first task until said second task completes its unit of work in response to an accumulated processor usage time of said first task being less than said accumulated processor usage time of said second task by a third threshold amount.

3. The method as recited in claim 1 further comprising:
identifying a priority of a first task and a second task involved in said potential deadlock;
suspending said first task until said second task completes its unit of work in response to said priority being assigned to said first task being lower than said priority assigned to said second task by a first threshold amount;
suspending said first task until said second task completes its unit of work in response to a current running time of said first task being less than said current running time of said second task by a second threshold amount; and
suspending said first task until said second task completes its unit of work in response to a remaining completion time of said first task exceeding said remaining completion time of said second task by a third threshold amount.

4. The method as recited in claim 1 further comprising:
monitoring said data concurrent processing system to collect additional system status data upon performing said action to resolve said potential deadlock;
determining if a system status of said data concurrent processing system returns to normal based on said additional system status data; and
analyzing a first process and a second process of said data concurrent processing system involved in said potential deadlock to determine if a deadlock exists in response to said system status of said data concurrent processing system not returning to normal.

5. The method as recited in claim 4 further comprising:
identifying a thread from one of said first process and said second process which can be revoked with a mutex safely; and
hanging said identified thread.

6. The method as recited in claim 5 further comprising:
releasing said mutex from said identified thread so that another thread acquires said mutex to access a shared resource; and
adding said identified thread to a queue for availability of said mutex.

7. The method as recited claim 6 further comprising:
calculating a reward of a current action to refine said trained model.

8. A computer program product for detecting and resolving deadlocks, the computer program product comprising one or more computer readable storage mediums having program code embodied therewith, the program code comprising programming instructions for:
training a model to detect potential deadlocks in data concurrent processing systems using collected static historical data;
monitoring a data concurrent processing system to collect system status data;
detecting a potential deadlock in said data concurrent processing system by said trained model using said collected system status data; and
performing an action to resolve said potential deadlock.

9. The computer program product as recited in claim 8, wherein the program code further comprises the programming instructions for:
identifying a priority of a first task and a second task involved in said potential deadlock;
suspending said first task until said second task completes its unit of work in response to said priority being assigned to said first task being lower than said priority assigned to said second task by a first threshold amount;
suspending said first task until said second task completes its unit of work in response to a remaining processor usage time of said first task exceeding said remaining processor usage time of said second task by a second threshold amount; and
suspending said first task until said second task completes its unit of work in response to an accumulated processor usage time of said first task being less than said accumulated processor usage time of said second task by a third threshold amount.

10. The computer program product as recited in claim 8, wherein the program code further comprises the programming instructions for:
identifying a priority of a first task and a second task involved in said potential deadlock;
suspending said first task until said second task completes its unit of work in response to said priority being assigned to said first task being lower than said priority assigned to said second task by a first threshold amount;
suspending said first task until said second task completes its unit of work in response to a current running time of said first task being less than said current running time of said second task by a second threshold amount; and
suspending said first task until said second task completes its unit of work in response to a remaining completion time of said first task exceeding said remaining completion time of said second task by a third threshold amount.

11. The computer program product as recited in claim 8, wherein the program code further comprises the programming instructions for:
monitoring said data concurrent processing system to collect additional system status data upon performing said action to resolve said potential deadlock;
determining if a system status of said data concurrent processing system returns to normal based on said additional system status data; and
analyzing a first process and a second process of said data concurrent processing system involved in said potential deadlock to determine if a deadlock exists in response to said system status of said data concurrent processing system not returning to normal.

12. The computer program product as recited in claim 11, wherein the program code further comprises the programming instructions for:
identifying a thread from one of said first process and said second process which can be revoked with a mutex safely; and
hanging said identified thread.

13. The computer program product as recited in claim 12, wherein the program code further comprises the programming instructions for:
releasing said mutex from said identified thread so that another thread acquires said mutex to access a shared resource; and
adding said identified thread to a queue for availability of said mutex.

14. The computer program product as recited claim 13, wherein the program code further comprises the programming instructions for:
calculating a reward of a current action to refine said trained model.

15. A system, comprising:
a memory for storing a computer program for detecting and resolving deadlocks; and
a processor connected to said memory, wherein said processor is configured to execute program instructions of the computer program comprising:
training a model to detect potential deadlocks in data concurrent processing systems using collected static historical data;
monitoring a data concurrent processing system to collect system status data;
detecting a potential deadlock in said data concurrent processing system by said trained model using said collected system status data; and
performing an action to resolve said potential deadlock.

16. The system as recited in claim 15, wherein the program instructions of the computer program further comprise:
identifying a priority of a first task and a second task involved in said potential deadlock;
suspending said first task until said second task completes its unit of work in response to said priority being assigned to said first task being lower than said priority assigned to said second task by a first threshold amount;
suspending said first task until said second task completes its unit of work in response to a remaining processor usage time of said first task exceeding said remaining processor usage time of said second task by a second threshold amount; and
suspending said first task until said second task completes its unit of work in response to an accumulated processor usage time of said first task being less than said accumulated processor usage time of said second task by a third threshold amount.

17. The system as recited in claim 15, wherein the program instructions of the computer program further comprise:
identifying a priority of a first task and a second task involved in said potential deadlock;
suspending said first task until said second task completes its unit of work in response to said priority being assigned to said first task being lower than said priority assigned to said second task by a first threshold amount;
suspending said first task until said second task completes its unit of work in response to a current running time of said first task being less than said current running time of said second task by a second threshold amount; and
suspending said first task until said second task completes its unit of work in response to a remaining completion time of said first task exceeding said remaining completion time of said second task by a third threshold amount.

18. The system as recited in claim 15, wherein the program instructions of the computer program further comprise:
monitoring said data concurrent processing system to collect additional system status data upon performing said action to resolve said potential deadlock;
determining if a system status of said data concurrent processing system returns to normal based on said additional system status data; and
analyzing a first process and a second process of said data concurrent processing system involved in said potential deadlock to determine if a deadlock exists in response to said system status of said data concurrent processing system not returning to normal.

19. The system as recited in claim 18, wherein the program instructions of the computer program further comprise:
identifying a thread from one of said first process and said second process which can be revoked with a mutex safely; and
hanging said identified thread.

20. The system as recited in claim 19, wherein the program instructions of the computer program further comprise:
releasing said mutex from said identified thread so that another thread acquires said mutex to access a shared resource; and
adding said identified thread to a queue for availability of said mutex.
